(19) United States
(12) Patent Application Publication
(10) Pub. No.: US 2014/0029564 A1
(43) Pub. Date: Jan. 30, 2014

(54) COMMUNICATION SYSTEM, COMMUNICATION APPARATUS AND RADIO RESOURCE ALLOCATING METHOD

(71) Applicants: Tomoko Harada, Kanagawa (JP); Takenobu Arima, Kanagawa (JP)

(72) Inventors: Tomoko Harada, Kanagawa (JP); Takenobu Arima, Kanagawa (JP)

(73) Assignee: Panasonic Mobile Communications Co., Ltd., Kanagawa (JP)

(21) Appl. No.: 14/111,709

(22) PCT Filed: Apr. 14, 2012
(86) PCT No.: PCT/JP2012/002584

§ 371 Date: Oct. 14, 2013

(30) Foreign Application Priority Data
Apr. 15, 2011 (JP) 2011-091082

(51) Int. Cl. H04W 72/10

(52) U.S. Cl. CPC H04W 72/10
USPC 370/329

(57) ABSTRACT

Provided is a communication system that can set, in an RLC layer, an RLC STATUS PDU without depending on the resource allocation of each of a plurality of LCHs and with the latest data state and that can generate an RLC data PDU. In this system, an RLC unit (RLC layer) (120) receives, from a MAC unit (MAC layer) (110), a total radio resource size together with the allocated radio resource size of each logic channel (LCH). Further, the RLC unit (RLC layer) (120) refers to the allocated size of each LCH and sets transport data of each LCH within the range of the total radio resource size.

### TECHNICAL FIELD

The present invention relates to a communication system, a communication apparatus, and a radio resource allocating method, and in particular, to a communication system, a communication apparatus, and a radio resource allocating method which execute allocation of radio resources in an RLC layer and a MAC layer of a 3GPP mobile communication system.

### BACKGROUND ART

In the present time, in Technical Specification Group Radio Access Network (TSG RAN) of 3rd Generation Partnership Project (3GPP), Long Term Evolution (LTE) as a next-generation mobile communication system has been studied.

In a radio link control (hereinafter, referred to as “RLC”) layer of LTE, as described in the standard in Non-Patent Literature (hereinafter, abbreviated as “NPL”) 1, for data transmission, data (RLC SDU) received from an upper layer is segmented and/or concatenated so as to fit within a transmittable size indicated from a lower layer, to generate an RLC PDU to which an RLC header is added.

FIG. 1 is a diagram showing how transmission data is generated in an RLC layer. A segmented RLC SDU is called an RLC SDU segment. The RLC layer generates an RLC PDU from an RLC SDU received from an upper layer, and transmits the RLC PDU to a lower layer. In the RLC layer, three operation modes; namely, a transparent data transfer mode (Transparent Mode: TM), an un-acknowledged data transfer mode (Un-acknowledged Mode: UM), and an acknowledged data transfer mode (Acknowledged Mode: AM) are provided according to various kinds of quality of service (QoS) required by a radio bearer (hereinafter, referred to as “RB”).

The AM mode provides an error correction function (ARQ: Automatic Repeat Request) by a retransmission mechanism of transmission data (hereinafter, referred to as “RLC data PDU”) to be transmitted from RLC to the lower layer. In ARQ, a data reception side sends a message (acknowledgement) indicating that data is correctly received, to a data transmission side, thereby allowing detection of whether or not data transmission is successful. When data transmission fails, data retransmission is executed, thereby increasing reliability of data transmission. Control data indicating acknowledgment is called an RLC STATUS PDU, and in the RLC layer, an RLC STATUS PDU is transmitted in priority to an RLC data PDU.

A medium access control (hereinafter, referred to as “MAC”) layer is located below the RLC layer. As described in the standard in NPL 2, in the MAC layer, mapping between a logical channel (hereinafter, referred to as “LCH”) and a transport channel (hereinafter, referred to as “TrCH”) is performed. Data (MAC SDU) on each LCH received from an upper layer is multiplexed onto a transport block (hereinafter, referred to as “TB”), and is transmitted to a lower layer through an appropriate TrCH.

In the MAC layer, when multiplexing data on various LCHs onto TBs, allocation of radio resources according to the priorities of LCHs (Logical Channel Prioritization, and hereinafter, referred to as “LCP”) is performed. In LCP, when multiplexing data of LCHs onto TBs, the amount of data transmission of each LCH is determined on the basis of the priority set for each LCH and a guaranteed band (Prioritized Bit Rate, and hereinafter, referred to as “PBR”).

Hereinafter, an allocation rule defined in NPL 2 will be described.

In the MAC layer, a value called Bucket size (Bj) is managed in each LCHj. Bj is calculated on the basis of the value of PBR, and the PBR is added to Bj for each TTI. At each transmission opportunity, LCP is executed in the following procedure.

Step 1: For all LCHs satisfying Bj>0, resource allocation is performed in order from an LCH having higher priority.

Step 2: The data size allocated in Step 1 is subtracted from Bj (Bj can be a negative value).

Step 3: When the radio resource remains after allocation of Step 1, allocation is performed in order from an LCH having higher priority until no transmission data or no resource remains, regardless of the value of Bj.

FIGS. 2 and 3 are diagrams showing an LCP application example. FIG. 2 shows an LCP example when a radio resource size a total allocated value of LCHs, and FIG. 3 shows an LCP example when a radio resource size<a total allocated value of LCHs.

It is assumed that the priority is set: LCH #1>LCH #2>LCH #3. In Step 1, resources are allocated in order of priority. Remaining resources are allocated in order from an LCH (in this ease, LCH #1) having higher priority in Step 3.

As shown in FIG. 2, when the size of a radio resource allocated to a UE at a single transmission opportunity is greater than the total value of allocated sizes of LCHs in Step 1, data transmission is possible through all the LCHs. This is because resource allocation is performed for all the LCHs.

As shown in FIG. 3, the size of a radio resource allocated to a UE may be smaller than the total value of allocated sizes of LCHs in Step 1. In this case, since allocation to LCHs (in this case, LCH #1 and LCH #2) having higher priority is given priority, resource allocation to an LCH (in this case, LCH #3) having lower priority is not performed. As a result, data transmission through the LCH having lower priority is not performed.

In the AM mode of the RLC layer, because of the presence of the ARQ function, it is necessary to transmit an acknowledgment (ACK) with an RLC STATUS PDU to indicate successful data reception to the counterpart RLC layer. In the counterpart RLC, data retransmission is executed when acknowledgment (ACK) cannot be received.

However, as described above, when no radio resource allocated for a data-receiving side LCH because of its low priority, there arises a problem in that an RLC STATUS PDU cannot be transmitted. Data retransmission is repeated when any acknowledgment cannot be received, and if the number of retransmissions reaches a prescribed upper limit value, reconnection of a link is triggered.

As a technique for solving a problem in that an RLC STATUS PDU of an LCH having low priority cannot be transmitted, a method described in Patent Literature (hereinafter, abbreviated as “PTL”) 1 is known.

PTL 1 proposes a method which transmits an RLC STATUS PDU in priority to an RLC data PDU of all LCHs.

FIG. 4 shows a control sequence of an RLC layer to a MAC layer described in PTL 1. FIG. 5 is a diagram showing a resource allocating method by LCP in a MAC layer according to the related art.

As shown in FIG. 4, according to the related art, the RLC layer computes the size of an RLC STATUS PDU and RLC data PDU and indicates the size to the MAC layer. In the MAC layer, radio resource allocation is performed on the basis of the indicated size of the RLC STATUS PDU of each LCH. At this time, as shown in FIG. 5, first, radio resource allocation is performed for an RLC STATUS PDU in order of priority in LCP. When there is a remaining resource, resource allocation is performed for an RLC data PDU in order of priority in LCP. In the RLC layer to which the allocated resource size is indicated by the MAC layer, an RLC STATUS PDU is transmitted in priority to an RLC data PDU. With this method, the problem in that no RLC STATUS PDU can be transmitted is solved.

### CITATION LIST

### Patent Literature

### PTL 1

Japanese Unexamined Patent Application Publication (Translation of PCT Application) No. 2010-521869

### Non-Patent Literature

### NPL 1

3GPP TS 36.322 V8.7.0 (2009-09) Radio Link Control (RLC) protocol specification (Release 8)

### NPL 2

3GPP TS 36.321 V8.7.0 (2009-09) Medium Access Control (MAC) protocol specification (Release 8)

### SUMMARY OF INVENTION

### Technical Problem

However, in the radio resource allocating method disclosed in PTL 1, it is necessary to separately manage the sizes of RLC data PDUs and RLC STATUS PDUs and to indicate the sizes to the MAC layer. In the MAC layer, during radio resource allocation in LCP, allocation needs to be performed taking into consideration the size of RLC STATUS PDU. In the RLC layer, an RLC STATUS PDU is transmitted on a priority basis according to the resource size of each LCH indicated by the MAC layer.

Accordingly, since interaction between the MAC layer and the RLC layer is required, when the amount of data of transmittable RLC data PDUs and RLC Status PDUs retained in the RLC layer changes during a period from size calculation in the RLC layer until execution of resource allocation in the MAC layer and data configuration in the RLC layer, appropriate resource allocation cannot be performed. That is, in the radio resource allocating method of PTL 1, there is a problem in that transmission in the latest data status cannot be performed.

In the radio resource allocating method of PTL 1, the size allocated to each LCH in the MAC layer is indicated to the RLC layer, and in the RLC layer, an RLC PDU is generated and transmitted within a resource allocated from the MAC layer to each LCH.

FIG. 6 is a diagram showing a data configuration method in an RLC layer according to the related art.

As shown in FIG. 6, an RLC SDU is segmented for each LCH, and RLC SDU segments are generated.

In an RLC header, it is necessary to configure an LI field (Length Indicator field), which represents the length of an RLC SDU or RLC SDU segment in an RLC PDU. For this reason, if an RLC SDU segment is generated in each LCH, the number of LI fields to be configured increases as the number of RLC SDUs increases, resulting an increase in the amount of the RLC header.

For this reason, in the radio resource allocating method of PTL 1, there is a problem in that radio resources cannot be effectively used.

An object of the present invention is to provide a communication system, a communication apparatus, and a radio resource allocating method capable of configuring an RLC STATUS PDU and generating an RLC data PDU in an RLC layer in the latest data status regardless of resource allocation of each LCH.

### Solution to Problem

A communication system according to an aspect of the present invention includes: a radio link control layer; and a medium access control layer, in which: the medium access control layer includes an indication section that indicates a total radio resource size along with an allocated radio resource size of each logical channel in radio resource size indication to the radio link control layer; and the radio link control layer includes: a reception section that receives the total radio resource size along with the allocated radio resource size of each logical channel from the medium access control layer; and a radio resource allocation section that configures transmission data on each logical channel within a range of the total radio resource size with reference to the allocated size of each logical channel.

A communication apparatus according to an aspect of the present invention includes: a radio link control layer; and a medium access control layer, in which the radio link control layer includes: a reception section that receives a total radio resource size along with an allocated radio resource size of each logical channel from the medium access control layer; and a radio resource allocation section that configures transmission data of each logical channel within a range of the total radio resource size with reference to the allocated size of each logical channel.

A data processing method according to an aspect of the present invention is a radio resource allocating method for a communication system including a radio link control layer and a medium access control layer, the method including: receiving, in the radio link control layer, a total radio resource size along with an allocated radio resource size of each logical channel from the medium access control layer; and configuring transmission data of each logical channel within a range of the total radio resource size with reference to the allocated size of each logical channel.

### Advantageous Effects of Invention

According to the invention, it is possible to configure an RLC STATUS PDU and also to generate an RLC data PDU in an RLC layer in the latest data status regardless of resource allocation of each LCH.

### BRIEF DESCRIPTION OF DRAWINGS

FIG. 1 is a diagram showing how transmission data is generated in an RLC layer;

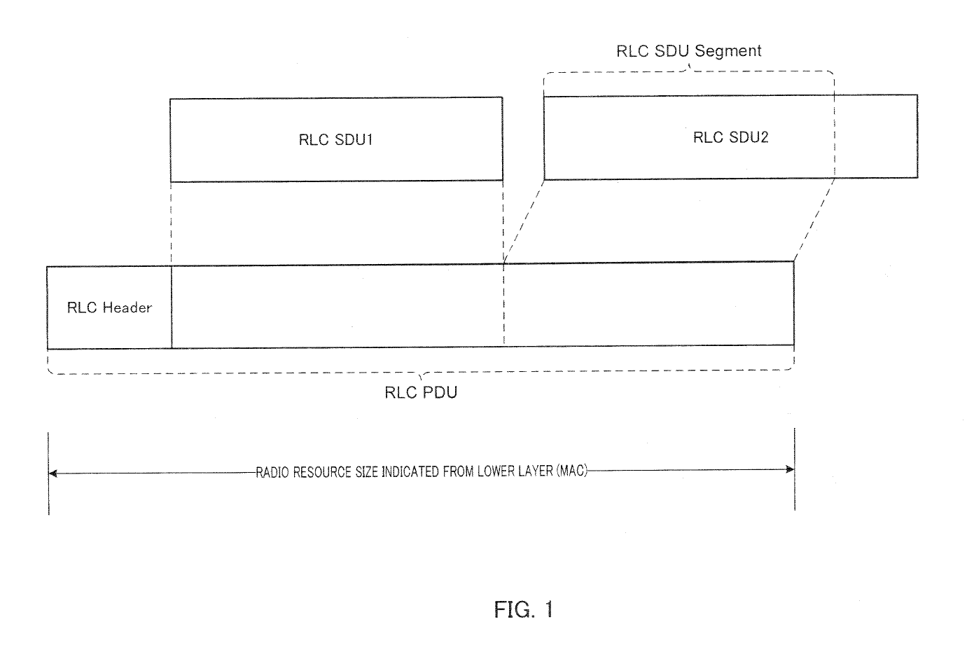

FIG. 2 is a diagram showing an LCP application example;

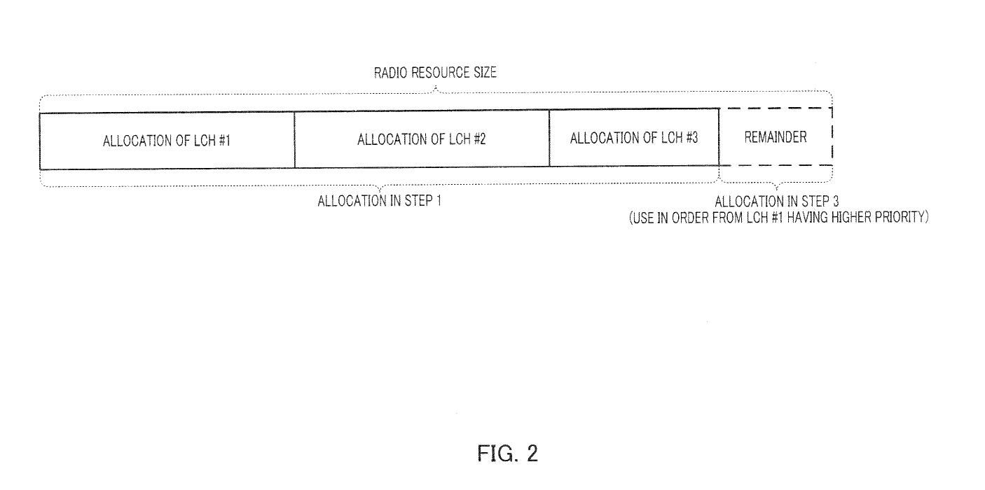

FIG. 3 is a diagram showing another LCP application example;

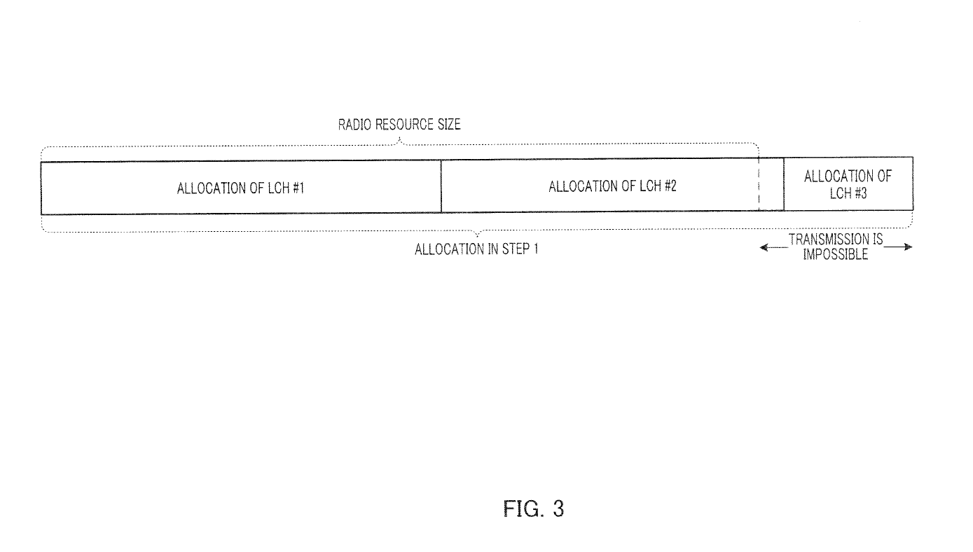

FIG. 4 is a control sequence diagram between an RLC layer and a MAC layer of the related art;

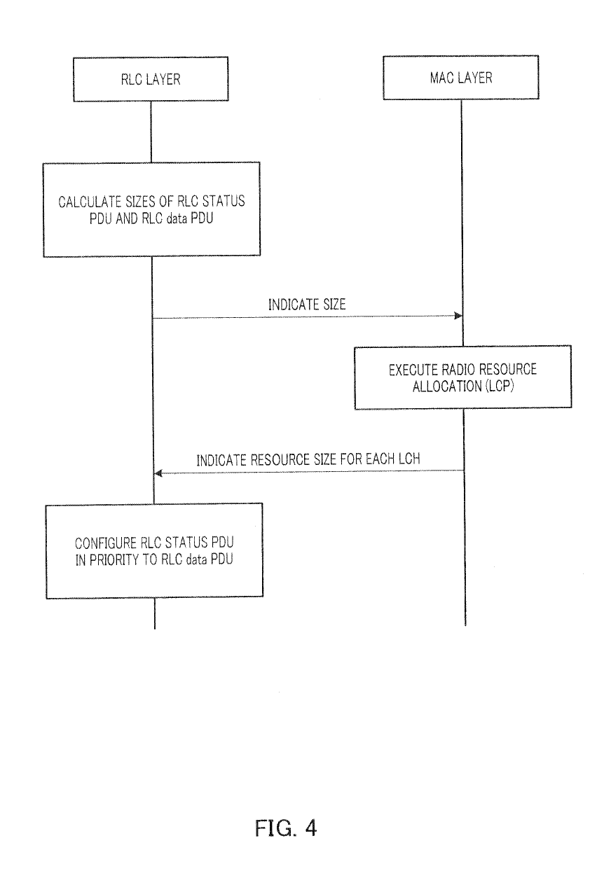

FIG. 5 is a diagram showing a resource allocating method by LCP in a MAC layer of the related art;

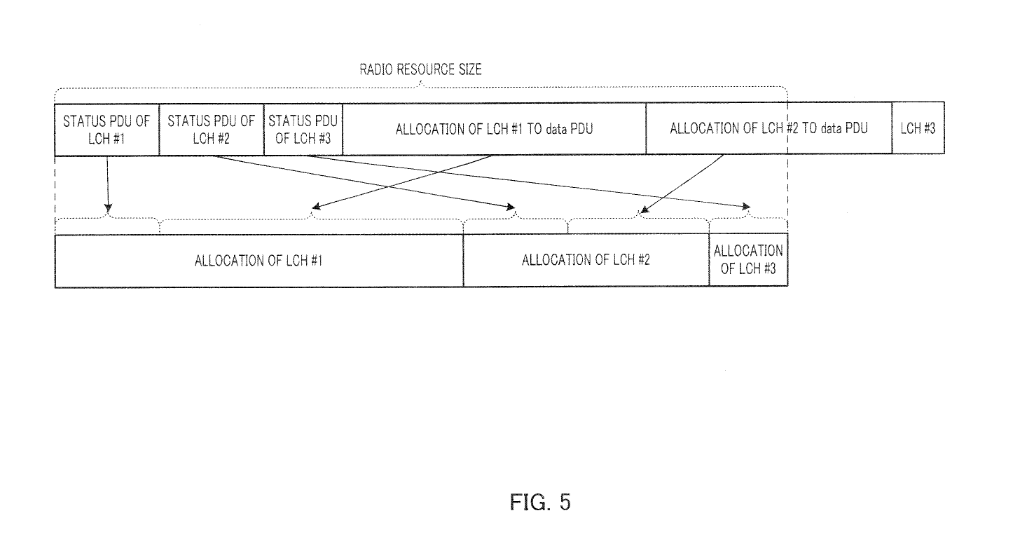

FIG. 6 is a diagram showing a data configuration method in an RLC layer of the related art;

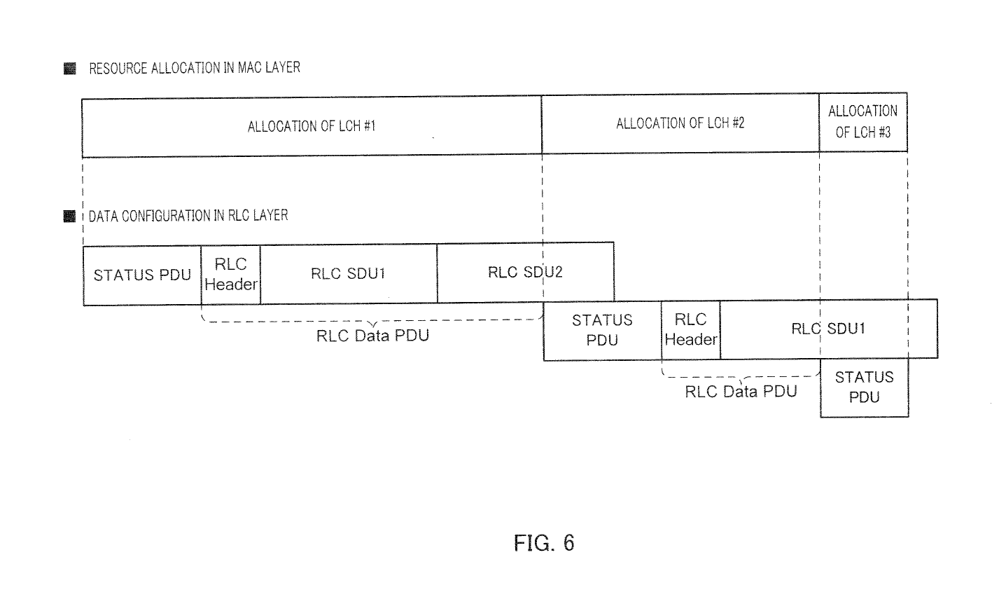

FIG. 7 is a block diagram showing the configuration of a communication apparatus according to Embodiment 1 of the invention;

FIG. 8 is a diagram illustrating a radio resource allocating method of a communication apparatus according to Embodiment 1;

FIG. 9 is a flowchart showing processing in an RLC section (RLC layer) of a communication apparatus to which the radio resource allocating method of Embodiment 1 is applied;

FIG. 10 is a flowchart showing processing in an RLC section (RLC layer) of a communication apparatus to which a radio resource allocating method according to Embodiment 2 of the invention is applied; and

FIG. 11 is a flowchart showing processing in an RLC section (RLC layer) of a communication apparatus to which a radio resource allocating method according to Embodiment 3 of the invention is applied.

### DESCRIPTION OF EMBODIMENTS

Hereinafter, embodiments of the invention will be described in detail with reference to the drawings.

### Embodiment 1

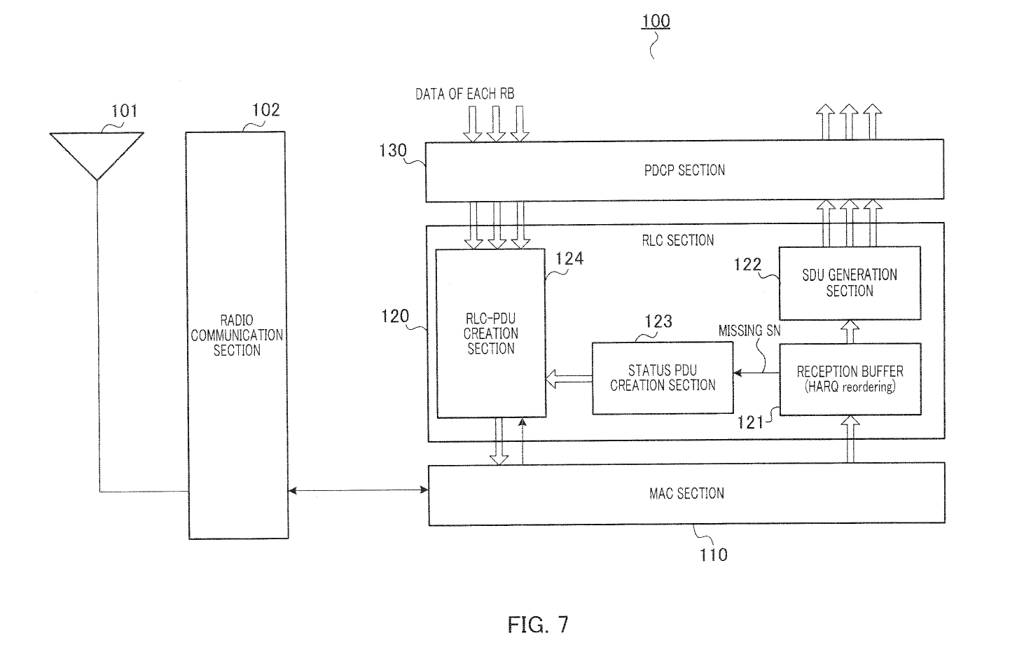

FIG. 7 is a block diagram showing a configuration of communication apparatus 100 according to Embodiment 1 of the invention.

Communication apparatus 100 primarily includes antenna 101, radio communication section 102, MAC section (MAC layer) 110, RLC section (RLC layer) 120, and packet data convergence protocol (PDCP) section (PDCP layer) 130. Communication apparatus 100 is, for example, a communication terminal apparatus, such as a mobile apparatus.

Antenna 101 receives a signal and outputs the signal to radio communication section 102. Antenna 101 transmits the signal received from radio communication section 102.

Radio communication section 102 converts the signal received from antenna 101 from a radio signal to a baseband signal, demodulates the signal, and outputs the resultant signal to MAC section 110. Radio communication section 102 modulates a transmission signal including a retransmission request received from MAC section 110, performs frequency conversion from a baseband frequency to a radio frequency, and outputs the resultant signal to antenna 101. Radio communication section 102 modulates a transmission signal including a message received from PDCP section 130 through RLC section 120 and MAC section 110, performs frequency conversion from a baseband frequency to a radio frequency, and outputs the resultant signal to antenna 101.

MAC section (MAC layer) 110 allocates a radio resource on the basis of a transmission data size indicated from RLC section (RLC layer) 120 and a PBR. In this case, MAC section 110 makes no distinction between data PDU/status PDU during size calculation in RLC section 120/resource allocation in MAC. That is, in this embodiment, in addition to allocation of each LCH, a total radio resource size is indicated from MAC section 110 to RLC section 120.

RLC section 120 includes reception buffer 121, SDU generation section 122, STATUS PDU creation section 123, and RLC-PDU creation section 124, and performs radio link control.

Reception buffer 121 receives reception data from MAC section 110, and performs reordering processing of ARQ and HARQ.

SDU generation section 122 generates an RLC-SDU for data ordered by reordering processing of ARQ and HARQ.

When a status PDU creation condition such as detection of missing data by reception buffer 121 is configured, STATUS PDU creation section 123 creates a status PDU.

RLC-PDU creation section 124 creates a data PDU (RLC-PDU) according to the amount of radio resource allocation indicated from MAC section 110 for transmission data (RLC-SDU) from PDCP section 130 and a status PDU or retransmission RLC-PDU, and transmits the data PDU (RLC-PDU) to MAC section 110.

RLC-PDU creation section 124 transmits a status PDU beyond the resource size of each LCH allocated from MAC within the total resource size. When a resource remains, RLC-PDU creation section 124 transmits a data PDU on the basis of LCP/PBR. At this time, a data PDU is configured in such a way that no RLC SDU is segmented when possible, regardless of allocation of each LCH.

In the manner described above, it is possible to suppress unnecessary MAC-RLC interaction and also to generate a PDU in the latest data status of RLC.

It also becomes possible to perform flexible data allocation within the total resources regardless allocation of each LCH. Since the number of segments decreases, the header size can be reduced. As a result, it is possible to achieve effective use of radio resources.

PDCP section 130 performs packet sequence control or the like during data encryption, decryption, and handover.

Hereinafter, a communication method in a communication system including communication apparatus 100 configured as above will be described.

In the following description of operation, MAC section (MAC layer) 110 is called a MAC layer, and RLC section (RLC layer) 120 is called an RLC layer for convenience of description.

Unlike PTL 1, the radio resource allocating method of this embodiment does not take into consideration the size of an RLC STATUS PDU during the calculation of transmission data size in the RLC layer and resource allocation of each LCH in the MAC layer. From the RLC layer to the MAC layer, a transmittable data size of each LCH is indicated without any distinction between the size of an RLC STATUS PDU and the size of an RLC data PDU. In the MAC layer, resource allocation of each LCH in Step 1 is performed on the basis of the transmission data size indicated from the RLC layer and the value of PBR.

In this embodiment, when indicating the resource size of each LCH allocated in the MAC layer to the RLC layer, in addition to the resource size of each LCH, the total radio resource size allocated to the UE is indicated.

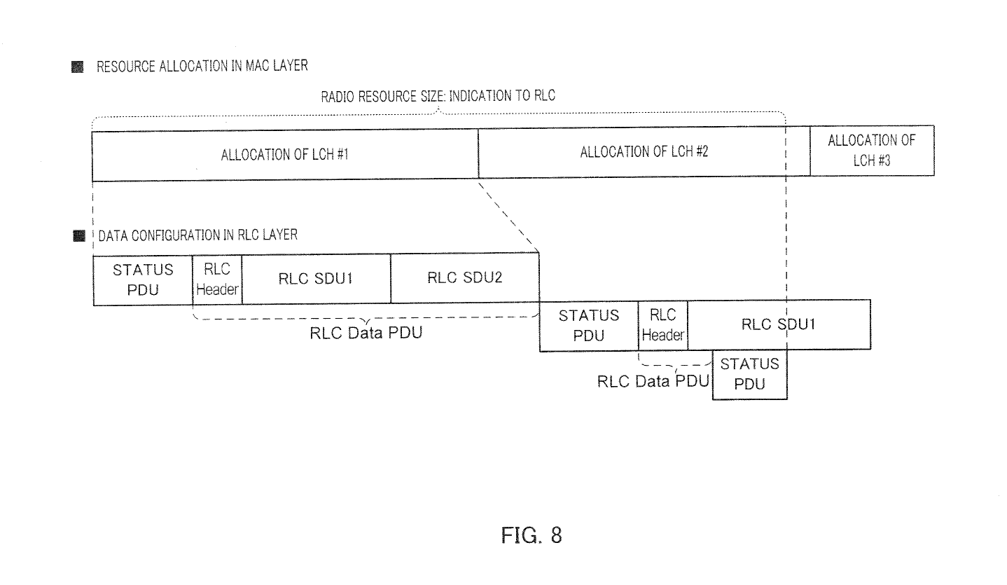

FIG. 8 is a diagram illustrating a radio resource allocating method of this embodiment. In FIG. 8, a data configuration method in an RLC layer is used as an example.

In the RLC layer, an RLC STATUS PDU needs to be transmitted in priority to an RLC data PDU. Accordingly, when there is an RLC STATUS PDU to be transmitted, RLC STATUS PDUs are configured in order from an LCH having higher priority if the data is within the total radio resource size. In the example of FIG. 8, while resource allocation in the MAC layer is not performed for LCH #3, an RLC STAUS PDU is configured.

When a radio resource remains after RLC STATUS PDUs are configured, RLC data PDUs are configured in order from an LCH having higher priority. At this time, the remainder of the total radio resource size is referenced, and if the data size is within the total size, the resource size of each LCH allocated from MAC is referenced, and an RLC data PDU is generated in such a way that no RLC SDU is segmented when possible.

As a method which configures an RLC data PDU in such a way that no RLC SDU is segmented when possible, there are the following methods (1) to (3).

(1) A method which configures an RLC SDU beyond the resource size of each LCH allocated from the MAC layer.

(2) A method which configures an RLC SDU within the resource size of each LCH allocated from the MAC layer.

(3) A method which configures an RLC SDU in such a way that an error from the resource size of each LCH allocated from the MAC layer decreases.

FIG. 8 shows an application example of a method which configures an RLC SDU beyond the resource size of each LCH allocated from the MAC layer.

In this example, when configuring an RLC data PDU in LCH #1 having the highest priority, an RLC data PDU is generated beyond an allocated resource size in the MAC layer, in such a way that RLC SDU 2 does not become an SDU segment.

If the above-described method is used, no RLC SDU segment is generated in an LCH having higher priority, and an RLC SDU segment is generated only in one LCH having low priority. In the example of FIG. 8, an RLC SDU segment is generated only in LCH #2.

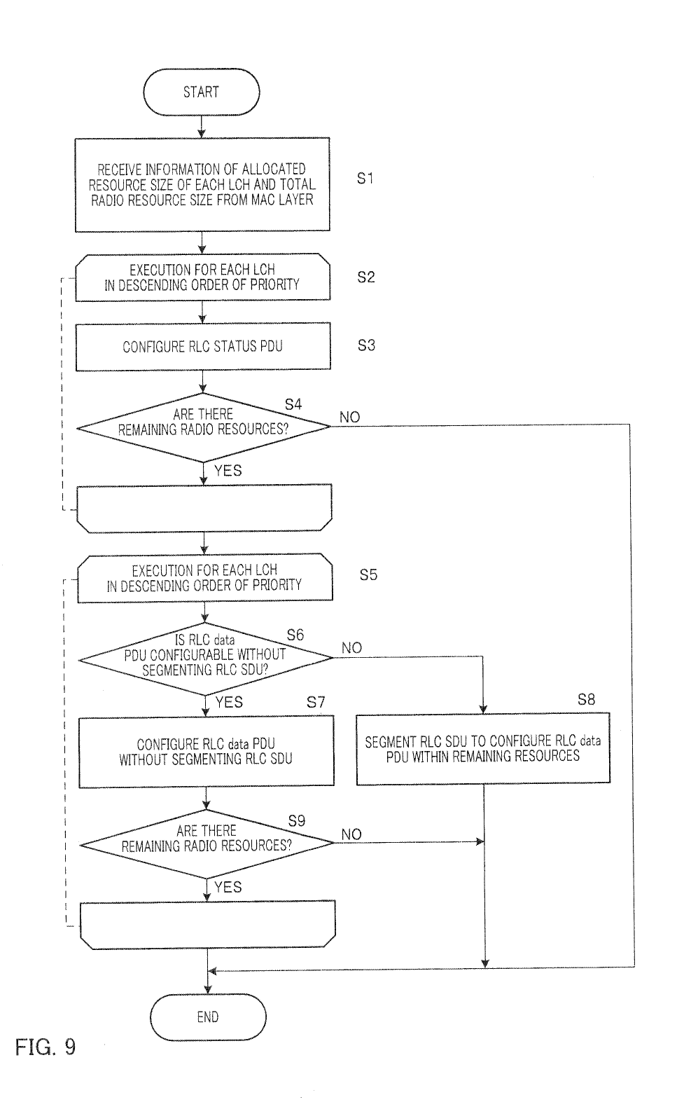

FIG. 9 is a flowchart showing processing in an RLC section (RLC layer) of a communication apparatus to which the radio resource allocating method of this embodiment is applied. In the drawing, “S” represents each step of the flow.

In Step S1, RLC section (RLC layer) 120 receives information of a total radio resource size along with an allocated resource size of each LCH from MAC section (MAC layer) 110.

An RLC STATUS PDU is configured in order from an LCH having higher priority (loop end: S2).

In Step S3, RLC section 120 configures RIX STATUS PDUs. RLC STATUS PDU configuration processing configures RLC STATUS PDUs of all LCHs, or is executed in a descending order of priority of LCHs until all radio resources are used.

After configuring the RLC STATUS PDUs, in Step S4, RLC section 120 determines whether or not there is the remainder of the radio resource size. After configuring the RLC STATUS PDUs, when there is no remainder of the radio resource size, this flow ends.

After configuring the RLC STATUS PDUs, when there is the remainder of the radio resource size, the flow is executed for each LCH in a descending order of priority through the loop termination (loop end: S5).

In Steps S6 to S9, RLC section 120 configures an RLC data PDU. Specifically, in Step S6, RLC section 120 determines whether or not an RLC data PDU can be configured in order from an LCH having higher priority without segmenting an RLC SDU. When an RLC data PDU can be configured without segmenting an RLC SDU, in Step S7, RLC section 120 configures the RLC data PDU without segmenting an RLC SDU. In Step S6, when an RLC data PDU cannot be configured without segmenting an RLC SDU within the remaining resources, in Step S7, RLC section 120 segments an RLC SDU to configure an RLC data PDU within the remaining resources.

In Step S7, when an RLC data PDU is configured without segmenting any RLC SDU, in Step S9, RLC section 120 determines whether or not there are remaining radio resources. When there are remaining radio resources, the above-described processing is repeated until there are no remaining radio resources. When there are no remaining radio resources, this flow ends.

In this way, the RLC data PDU configuration processing configures RLC SDUs of all LCHs, or is executed in a descending order of priority of LCHs until all radio resources are used.

As described above in detail, in communication apparatus 100 to which the radio resource allocating method of this embodiment is applied, MAC section (MAC layer) 110 indicates the total radio resource size along with the allocated radio resource size of each logical channel (LCH) when indicating the radio resource size to RLC section (RLC layer) 120. RLC section (RLC layer) 120 receives the total radio resource size along with the allocated radio resource size of each logical channel (LCH) from MAC section (MAC layer) 110. In RLC section (RLC layer) 120, the allocated size of each LCH is referenced, and transmission data of each LCH is configured within a range of the total radio resource size.

Accordingly, it becomes possible to configure an RLC STATUS PDU and to generate an RLC data PDU in the latest data status regardless of resource allocation of each LCH in RLC section (RLC layer) 120.

Since flexible data allocation is possible within the total radio resource size, it becomes possible to generate an RLC data PDU in such a way that no RLC SDU segment is generated when possible, and thus to reduce the RLC header size.

In this way, in the radio resource allocating method of the invention, it becomes possible to achieve effective use of radio resources compared with the related art.

In particular, in this embodiment, since it is possible to transmit an RLC STATUS PDU on a priority basis, to perform radio resource allocation according to the latest amount of data, and to reduce redundant RLC header, effective use of radio resources can be achieved.

### Embodiment 2

In the radio resource allocating method of Embodiment 1, the RLC STATUS PDU configuration processing and the RLC data PDU configuration processing may be executed separately and alone.

Embodiment 2 relates to processing when the RLC STATUS PDU configuration processing is executed alone.

The basic configuration and operation of a communication apparatus according to Embodiment 2 of the invention are the same as those in Embodiment 1.

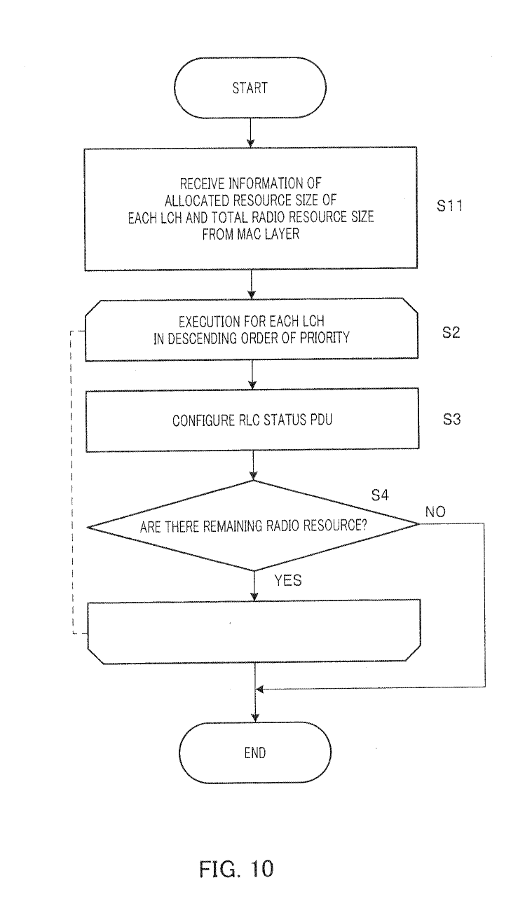

FIG. 10 is a flowchart showing processing in an RLC section (RLC layer) of the communication apparatus to which a radio resource allocating method according to Embodiment 2 of the invention is applied. The steps in which the same processing as that in the flow of FIG. 9 is performed are represented by the same reference numerals.

In Step S11, RLC section (RLC layer) 120 receives information of a total radio resource size along with an allocated resource size of each LCH from MAC section (MAC layer) 110.

An RLC STATUS PDU is configured in order from an LCH having higher priority (loop end: S2).

In Step S3, RLC section 120 configures an RLC STATUS PDU. The RLC STATUS PDU configuration processing configures RLC STATUS PDUs of all LCHs or is executed in a descending order of priority of LCHs until all radio resources are used.

After configuring the RLC STATUS PDUs, in Step S4, RLC section 120 determines whether or not there is the remainder of the radio resource size. After configuring the RLC STATUS PDUs, when there is no remainder of the radio resource size, this flow ends. When there are remaining radio resources, the above-described processing is repeated until no radio resources remain.

In this way, in this embodiment, RLC section (RLC layer) 120 receives information of the total radio resource size along with the allocated resource size of each LCH from MAC section (MAC layer) 110.

An RLC STATUS PDU is configured in order from an LCH having higher priority. The RLC STATUS PDU configuration processing configures RLC STATUS PDUs of all LCHs, or is executed in a descending order of priority of LCHs until all radio resources are used.

Accordingly, in this embodiment, it is possible to transmit RLC STATUS PDUs on a priority basis, and to effectively use radio resources according to the latest amount of data of RLC STATUS PDUs.

### Embodiment 3

Embodiment 3 relates to processing when the RLC data PDU configuration processing is executed alone.

The basic configuration and operation of a communication apparatus according to Embodiment 3 of the invention are the same as those in Embodiment 1.

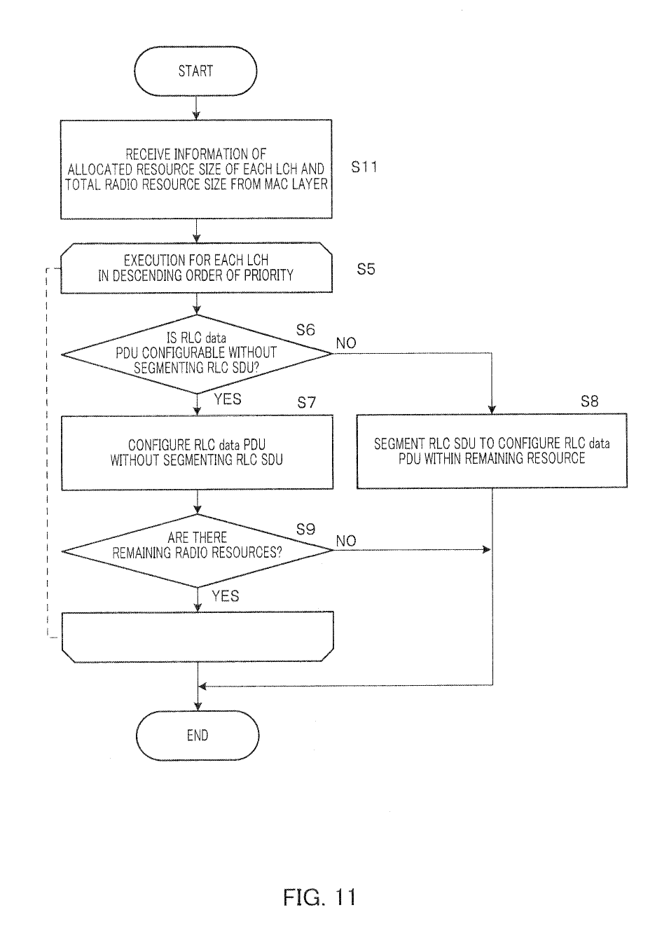

FIG. 11 is a flowchart showing processing in an RLC section (RLC layer) of a communication apparatus to which a radio resource allocating method according to Embodiment 3 of the invention is applied. The steps in which the same processing as the flow of FIGS. 9 and 10 are represented by the same reference numerals.

In Step S11, RLC section (RLC layer) 120 receives information of a total radio resource size along with an allocated resource size of each LCH from MAC section (MAC layer) 110.

At a loop end S5, the flow is executed for each LCH in a descending order of priority.

In Steps S6 to S9, RLC section 120 configures an RLC data PDU. Specifically, in Step S6, RLC section 120 determines whether or not an RLC data PDU can be configured in order from an LCH having higher priority without segmenting an RLC SDU. When an RLC data PDU can be configured without segmenting any RLC SDU, in Step S7, RLC section 120 configures an RLC data PDU without segmenting any RLC SDU. In Step S6, when an RLC data PDU cannot be configured without segmenting an RLC SDU within the remaining resources, in Step S8, RLC section 120 segments an RLC SDU to configure the RLC data PDU within the remaining resources.

In Step S7, when an RLC data PDU is configured without segmenting any RLC SDU, in Step S9, RLC section 120 determines whether or not there are remaining radio resources. When there are remaining radio resources, the above-described processing is repeated until no radio resources remain. When there are no remaining radio resources, this flow ends.

In this way, in this embodiment, RLC section (RLC layer) 120 receives information of a total radio resource size along with an allocated resource size of each LCH from MAC section (MAC layer) 110.

It is determined whether or not an RLC data PDU can be configured in order from an LCH having higher priority without segmenting any RLC SDU, and if it is possible to configure an RLC data PDU, the RLC data PDU is configured. When an RLC data PDU cannot be configured without segmenting an RLC SDU within the remaining resources, an RLC SDU is segmented to configure the RLC data PDU within the remaining resources. The RLC data PDU configuration processing configures RLC SDUs of all LCHs, or is executed in a descending order of priority of LCHs until all radio resources are used.

As described above, in this embodiment, since it becomes possible to perform radio resource allocation according to the latest amount of data, and to reduce redundant RLC header, effective use of radio resources can be achieved.

The above description is an illustration of a preferred embodiment of the invention, and the scope of the invention is not limited thereto.

For example, although in the foregoing embodiments, the MAC section, the RLC section, and the RRC section are provided, the invention is not limited thereto, and a configuration which performs any protocol processing for performing the same processing as each of the MAC section, the RLC section, and the RRC section, other than these sections may be employed.

In the foregoing embodiments, the titles including a communication system, a communication apparatus, and a radio resource allocating method have been used for convenience, but the apparatus may be a radio communication terminal, an LTE terminal, or a mobile communication system, and the method may be a communication control method or the like.

The type, protocol processing, and the like of each component section which forms the communication apparatus, for example, the radio communication section is not limited to those described in the foregoing embodiments.

Although the above-noted embodiments have been described by examples of hardware implementations, the present invention can also be implemented by software in conjunction with hardware.

The functional blocks used in the descriptions of the above-noted embodiments are typically implemented by LSI devices, which are integrated circuits. These may be individually implemented as single chips and, alternatively, a part or all thereof may be implemented as a single chip. The term LSI devices as used herein, depending upon the level of integration, may refer variously to ICs, system LSI devices, very large-scale integrated devices, and ultra-LSI devices.

The method of integrated circuit implementation is not restricted to LSI devices, and implementation may be done by dedicated circuitry or a general-purpose processor. After fabrication of an LSI device, a programmable FPGA (field-programmable gate array) or a re-configurable processor that enables reconfiguration of connections of circuit cells within the LSI device or settings thereof may be used.

Additionally, in the event of the appearance of technology for integrated circuit implementation that replaces LSI technology by advancements in semiconductor technology or technologies derivative therefrom, that technology may of course be used to integrate the functional blocks. Another possibility is the application of biotechnology or the like.

The disclosure of the specification, drawings, and abstract of Japanese Patent Application No. 2011-91082, filed on Apr. 15, 2011, is incorporated herein by reference in its entirety.

### INDUSTRIAL APPLICABILITY

The communication system, the communication apparatus, and the radio resource allocating method of the present invention are useful for a 3GPP mobile communication system in which ARQ is executed in an RLC layer, and LCP is executed in a MAC layer, for example.

### REFERENCE SIGNS LIST

100 Communication apparatus
101 Antenna
102 Radio communication section
110 MAC section (MAC layer)
120 RLC section (RLC layer)
121 Reception buffer
122 SDU generation section
123 STATUS PDU creation section
124 RLC-PDU creation section
130 PDCP section (PDCP layer)

1. A communication system comprising:
a radio link control layer; and
a medium access control layer, wherein:
the medium access control layer comprises
an indication section that indicates a total radio resource size along with an allocated radio resource size of each logical channel in radio resource size indication to the radio link control layer; and
the radio link control layer comprises:
a reception section that receives the total radio resource size along with the allocated radio resource size of each logical channel from the medium access control layer; and
a radio resource allocation section that configures transmission data on each logical channel within a range of the total radio resource size with reference to the allocated size of each logical channel.

2. A communication apparatus comprising:
a radio link control layer; and
a medium access control layer, wherein
the radio link control layer comprises:
a reception section that receives a total radio resource size along with an allocated radio resource size of each logical channel from the medium access control layer; and
a radio resource allocation section that configures transmission data of each logical channel within a range of the total radio resource size with reference to the allocated size of each logical channel.

3. The communication apparatus according to claim 2, wherein the radio link control layer configures, in order from a logical channel having higher priority, a STATUS PDU in priority to a data PDU within a range of the total radio resource size indicated from the medium access control layer.

4. The communication apparatus according to claim 2, wherein the radio link control layer configures, in order from a logical channel having higher priority, a data PDU in such a way that no SDU is segmented within a range of the total radio resource size based on the resource size of each logical channel indicated from the medium access control layer.

5. The communication apparatus according to claim 2, wherein:
the radio link control layer configures, in order from a logical channel having priority, a STATUS PDU in priority to a Data PDU within a range of the total radio resource size indicated from the medium access control layer; and
when there are remaining radio resources, the radio link control layer configures, in order from a logical channel having higher priority, a data PDU in such a way that no SDU is segmented within a range of the remaining radio resources based on the resource size of each logical channel indicated from the medium access control layer.

6. A radio resource allocating method for a communication system including a radio link control layer and a medium access control layer, the method comprising:
receiving, in the radio link control layer, a total radio resource size along with an allocated radio resource size of each logical channel from the medium access control layer; and
configuring transmission data of each logical channel within a range of the total radio resource size with reference to the allocated size of each logical channel.
